(19) United States
(12) Patent Application Publication
(10) Pub. No.: US 2020/0309027 A1
(43) Pub. Date: Oct. 1, 2020

(54) GAS TURBINE ENGINE WITH AN ELECTROMAGNETIC TRANSMISSION

(71) Applicant: Rolls-Royce Deutschland Ltd & Co KG, Blankenfelde-Mahlow (DE)

(72) Inventor: Iivo RYTKÖNEN, Blankenfelde-Mahlow (DE)

(21) Appl. No.: 16/822,499

(22) Filed: Mar. 18, 2020

(30) Foreign Application Priority Data
Mar. 27, 2019 (DE) 10 2019 204 257.0

(51) Int. Cl. F02C 6/20

(52) U.S. Cl. CPC F02C 6/20; F05D 2220/76; F05D 2220/323

(57) ABSTRACT

A gas turbine engine, in particular for an airplane, includes a bladed rotor, a shaft driven by a turbine and an electrical generator including first and second generator components that can be rotated and magnetically coupled to one another, the first one being fixed to the shaft and the second one being mechanically coupled to the bladed rotor so as to drive the bladed rotor.

This application claims priority to German Patent Application DE102019204257.0 filed Mar. 27, 2019, the entirety of which is incorporated by reference herein.

### DESCRIPTION

The present disclosure relates to gas turbines, in particular to gas turbine engines for aircrafts.

It is an ongoing effort to reduce the fuel consumption of gas turbine engines and, in particular, of gas turbine engines of airplanes. In recent years, turbofan engines have been developed with increasing fan diameter; however, there are constraints for a further increase of the fan diameter. As an example, to maintain a subsonic fan blade tip velocity, a maximum fan diameter usually follows from a given speed of a turbine stage driving the fan.

It is an object to further reduce the fuel consumption of a gas turbine engine.

According to a first aspect there is provided a gas turbine engine, in particular for an airplane. The gas turbine engine comprises: a bladed rotor, i.e. a rotor with blades, a shaft driven by a turbine, and an electrical generator including first and second generator components. The first and second generator components are rotatable with respect to one another and are or can be magnetically coupled to one another. The first generator component is fixed to the shaft. The second generator component is mechanically coupled to the bladed rotor to drive the bladed rotor (by means of mechanical forces and without electromagnetic forces).

In this arrangement the bladed rotor and the shaft may rotate at different speeds. In particular, the bladed rotor may rotate at a lower speed than the shaft. Therefore, the speeds of the bladed rotor and of the shaft may each be optimized individually and variably. With respect to a common gas turbine engine providing the same thrust, the gas turbine engine described above may be scaled down in size and may save fuel. Loads on the bladed rotor and other parts of the gas turbine engine may be adjusted rapidly. The electrical generator may be adapted to be magnetized in dependence of a current operating status of the gas turbine engine (e.g., one of engine start, take-off, cruise and landing).

Via the shaft and the electrical generator, the turbine may provide torque to the bladed rotor. The turbine is rotatable with respect to a support structure of the gas turbine engine. The second generator component is rotatable with respect to the support structure.

The second generator component may be fixedly connected to the bladed rotor. This allows a particularly simple, yet efficient, arrangement.

Optionally, the first generator component is a generator rotor and the second generator component is a generator stator. The generator rotor may be lighter than the generator stator. Fixing the generator rotor to the shaft may allow quick changes in the speed of the shaft. Alternatively, the first generator component is a generator stator and the second generator component is a generator rotor.

The gas turbine engine may further comprise an electric motor. The electric motor may be adapted for driving the bladed rotor. The electric motor may provide additional torque to the bladed rotor. The motor may be activated in specific situations, e.g. at take-off. Further, the electric motor may drive the bladed rotor even if in cases of an engine failure and/or when fuel is exhausted. A stator of the electric motor may be fixed with respect to the support structure.

Optionally, the bladed rotor is arranged between the electrical motor and the electrical generator. This allows an arrangement of the bladed rotor close to, e.g., adjacent, the electrical generator. As an example, the electric motor may be arranged in a nose cone of the bladed rotor.

Alternatively, the electrical motor is arranged between the bladed rotor and the electrical generator. This allows a close arrangement of the electrical components. The electrical generator and the electric motor may be arranged coaxially at a common axis of rotation. Optionally, the electrical generator and the electric motor are arranged side-by-side and/or one after the other along the common axis of rotation.

The electric motor and the bladed rotor may be coupled with one another via an epicyclic gearing. By this the electric motor may run at higher speeds than the bladed rotor. So the electric motor can be used in an efficient speed and load area. In general, the electric motor and the bladed rotor may be coupled with one another via a reduction gearing, in particular via a reduction gearing that allows the electric motor to run at higher speeds than the bladed rotor.

Optionally, the epicyclic gearing is arranged between the bladed rotor and the electrical motor. This allows for a compact design.

The electrical generator may be adapted to generate electrical power. Particularly, the electrical generator may be adapted to provide electrical power to the electric motor. The electrical generator may thus magnetically transmit torque to the bladed rotor and, additionally, generate electrical power, in particular to drive the electric motor to provide further torque to the bladed rotor. The electrical power may be provided to one or more external devices, e.g. to one or more devices of an airplane. In an alternative, the no electric motor is provided and, optionally, all electrical power from the electrical generator is provided to one or more external devices.

The gas turbine engine may further comprise a frequency converter. The frequency converter may be electrically coupled to the electrical generator and/or the electric motor. According to an embodiment, the frequency converter couples the electrical generator with the electrical motor. The frequency converter may be adapted to change a frequency of an electric current provided by the electrical generator for the electric motor, in particular in dependence of a speed (e.g., a present speed or a speed set point) of the electric motor.

According to an embodiment the gas turbine engine further comprises an electrical energy storage adapted to store electrical power. The electrical storage may be adapted to provide electrical power to the electric motor. This allows to store electrical power in situations when more power is produced than needed, and to use the stored electrical power in situations when more power is needed (in particular on a very short time scale) than currently produced by the turbine. Further, the electrical energy storage allows a fast acceleration of the bladed rotor with a reduced electrical generator load.

The energy storage may comprise at least one of a battery and a supercapacitor. This allows an efficient storage and high input and/or output currents. The battery and/or supercapacitor may be chargeable by energy from an electrical grid when the gas turbine engine (in particular an airplane comprising the gas turbine engine) is on the ground. So optionally, the battery and/or supercapacitor is charged when a grid connection is possible. This allows to further save combustion fuel.

The energy storage may be coupled to the electrical generator so as to receive electrical energy from the electrical generator. Alternatively or in addition, the energy storage may be coupled to a solar panel and/or a thermoelectric generator to receive electrical energy from the solar panel and/or the thermoelectric generator. This may further decrease the fuel consumption. The gas turbine engine may be adapted to stop the combustion of fuel in certain situations, e.g. when only little thrust is needed and/or when flying over an inhabited area.

The bladed rotor may be a fan. The gas turbine engine may be a turbofan engine. The gas turbine engine may have (precisely) one fan.

According to an aspect, an airplane is provided. The airplane comprises at least one gas turbine engine according to any embodiment described herein.

According to an aspect, a method for operating the gas turbine engine according to any embodiment described herein is provided. The method comprises a step of magnetically transmitting torque by means of the electrical generator.

The method may further comprise magnetizing the electrical generator of the gas turbine engine in dependence of a current operating status of the gas turbine engine. The current operating status may be, e.g., one of engine start, take-off, cruise and landing.

The gas turbine engine may further comprise an electric motor for driving the bladed rotor, wherein the method further comprises a step of providing electrical power to the electric motor in dependence on the current operating status of the gas turbine engine.

As noted elsewhere herein, the present disclosure relates to a gas turbine engine. Such a gas turbine engine may comprise an engine core comprising a turbine, a combustor, a compressor, and a core shaft operatively connecting the turbine to the compressor. Such a gas turbine engine may comprise a fan (having fan blades) located upstream of the engine core.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350cm, 360cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Utip. The work done by the fan blades on the flow results in an enthalpy rise dH of the flow. A fan tip loading may be defined as dH/Utip2, where dH is the enthalpy rise (for example the 1-D average enthalpy rise) across the fan and Utip is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg-1K-1/(ms-1)2). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1 s, 105 Nkg-1 s, 100 Nkg-1 s, 95 Nkg-1 s, 90 Nkg-1 s, 85 Nkg-1 s or 80 Nkg-1 s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C (ambient pressure 101.3 kPa, temperature 30 deg C), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Embodiments will now be described by way of example only, with reference to the Figures, in which:

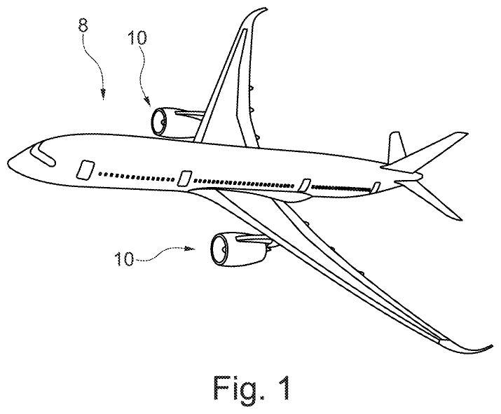

FIG. 1 is a perspective view of an aircraft having a plurality of gas turbine engines;

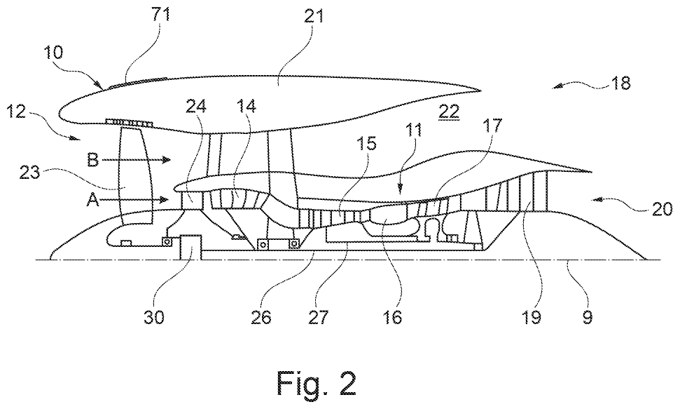

FIG. 2 is a sectional side view of a gas turbine engine;

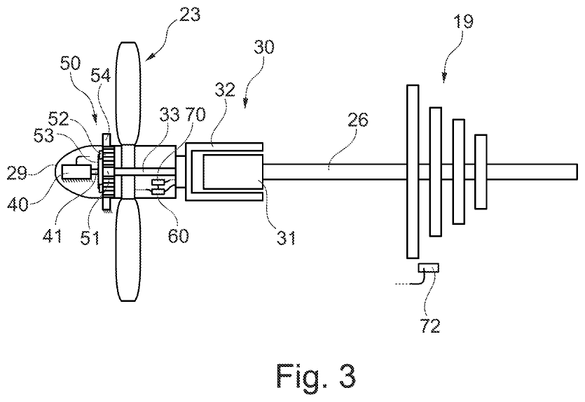

FIG. 3 is a schematic side view of a portion of a gas turbine engine having a fan driven via an electromagnetic transmission gear and an electric motor coupled to a planet carrier of an epicyclic gearing;

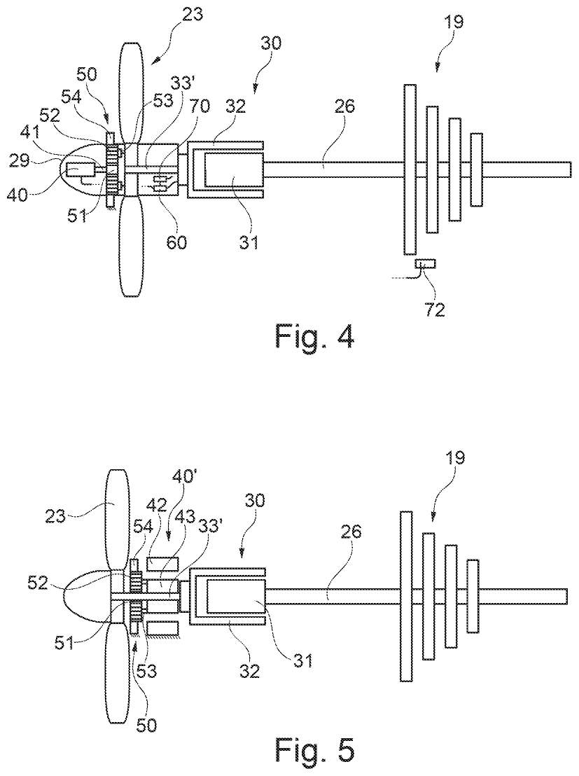

FIG. 4 is a schematic side view of a portion of a gas turbine engine having a fan driven via an electromagnetic transmission gear and an electric motor coupled to a sun gear of an epicyclic gearing;

FIG. 5 is a schematic side view of a portion of a gas turbine engine having a fan driven via an electromagnetic transmission gear and an electric motor arranged between the fan and the electromagnetic transmission gear; and

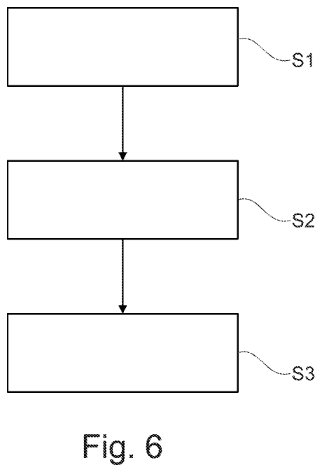

FIG. 6 is a method for controlling a gas turbine engine.

FIG. 1 shows an aircraft 8 in the form of a passenger aircraft. Aircraft 8 comprises several (i.e., two) gas turbine engines 10. The gas turbine engines 10 will be described in more detail below with particular reference to FIG. 2. One or more of the gas turbine engines 10 comprise an electromagnetic transmission gear, in particular in accordance with any one of FIGS. 3 to 5.

FIG. 2 illustrates a gas turbine engine 10 of the aircraft 8. The gas turbine engine 10 is an aero engine. The gas turbine engine 10 has a principal rotational axis 9. The engine 10 comprises an air intake 12 and a propulsive fan 23 (a bladed rotor) that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is driven by the low pressure turbine 19 via a shaft 26 (low-pressure shaft) and an electromagnetic transmission gear comprising an electrical generator 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27 (high-pressure shaft). The fan 23 generally provides the majority of the propulsive thrust.

FIG. 3 shows an arrangement for the gas turbine engine 10 according to FIG. 2. According to an embodiment, the gas turbine engine 10 of FIG. 2 comprises the arrangement of FIG. 3.

FIG. 3 schematically shows the low-pressure turbine 19 being fixedly connected to the (low-pressure) shaft 26. The shaft 26 is driven by the low-pressure turbine 19.

The shaft 26 is coupled to an electrical generator 30. The electrical generator 30 comprises a generator rotor 31 as a first generator component and a generator stator 32 as a second generator component. The generator rotor 31 is rotatable relative to the generator stator 32. The generator rotor 31 and the generator stator 32 are or can be magnetically coupled to one another. The generator stator 32 surrounds the generator rotor 31. The generator rotor 31 is accommodated within the generator stator

The generator stator 32 is fixedly connected with the fan 23 (the bladed rotor), in the present example by means of a link 33.

One of the generator stator 32 and the generator rotor 31 comprises an armature for producing electrical power. The other one of the generator stator 32 and the generator rotor 31 comprises a field winding and/or at least one permanent magnet.

The electrical generator 30 is an alternator. In alternative embodiments the electrical generator may be a dynamo.

Both the generator rotor 31 and the generator stator 32 are rotatable with respect to the support structure of the gas turbine engine 10 (e.g., the nacelle 21).

Via the electrical generator 30 the shaft 26 may transmit (in use: transmits) torque to the fan 23 (e.g., depending on a magnetization of the field winding). The electrical generator 30 thus works as a magnetic coupling. In view of the electromagnetic nature of this coupling, the electrical generator 30 may also be referred to as an electromagnetic transmission.

In addition, the electrical generator 30 may produce electrical power due to a difference in relative movement between the generator stator 32 and the generator rotor 31. The fan 23 rotates at a lower speed than the shaft 26. Half of the shaft 23 torque is transferred to the fan 23. For example, the shaft 26 may rotate with 3000 rpm and the fan 23 may rotate at 1000 rpm (e.g., with respect to the nacelle 21 or another support structure such as support structure 24 shown in FIG. 2). As a result, the speed of the electrical generator 30 will be 2000 rpm. The speed of the electrical generator 30 is adjustable in dependence of the magnetization of the electrical generator 30 (e.g., the magnetization of the field winding). Also the load of the engine may be adjusted by the magnetization of the electrical generator 30. The torque transferred from the generator rotor 31 to the generator stator 32 is half of the shaft 26 torque.

Further, an electric motor 40 is provided. In the present example, the electric motor 40 is arranged in a nose cone 29 of the fan 23. The electric motor 40 comprises a housing that is fixed to a stationary support structure or the gas turbine engine 10. The electric motor 40 comprises an output shaft 41 rotatable with respect to the housing.

The electric motor 40 is coupled to the fan 23 so as to drive the fan 23. When the electric motor 40 is activated, the load in the electrical generator 30 and the and core engine can be reduced. In the example of FIG. 3, the electric motor 40 is coupled to the fan 23 by means of a reduction gearing. According to FIG. 3, the reduction gearing is an epicyclic gearing 50.

The epicyclic gearing 50 comprises a sun gear 51, a plurality of planet gears 32 and a ring gear 54. Each planet gear 52 is in engagement with the (inner) sun gear 51 and the (outer) ring gear 54. Each planet gear 52 is rotatably mounted on a planet carrier 53.

The output shaft 41 of the electric motor 40 is fixed to the planet carrier 53. An activation of the electric motor 40 rotates the planet carrier 53 with respect to the ring gear 54. By this, the planet gears 52 roll along the ring gear 54 and thereby rotate on the planet carrier 53. Thereby the sun gear 51 is rotated with respect to the ring gear 54. The ring gear 54 is fixed with respect to the support structure of the gas turbine engine 10.

The sun gear 51 of the epicyclic gearing 50 is fixed to the fan 23. In the example of FIG. 3, the sun gear 51 is fixed to the link 33.

An activation of the electric motor 40 exerts a torque on the fan 23. The electric motor 40 is adapted for driving the fan 23.

According to FIG. 3 (and seen in axial direction of the principal rotational axis 9), the epicyclic gearing 50 is arranged between (and adjacent to) the electric motor 40 and the fan 23. The fan 23 is arranged between (and adjacent to) the electrical generator 30 and the epicyclic gearing 50. Further, the fan 23 is arranged between the electric motor 40 and the electrical generator 30. The epicyclic gearing 50 is arranged between the electric motor 40 and the electrical generator 30.

A frequency converter 60 is electrically coupled to the electrical generator 30. The frequency converter 60 is adapted to receive input current with a frequency and to provide output current with the same or a different frequency. The frequency converter 60 may be adjustable so as to adjust the frequency of the output current. The frequency converter 60 is electrically coupled to the electric motor 40. The frequency converter 60 provides the output current to the electric motor 40.

Alternatively or in addition, electrical power from the electrical generator 30 may be supplied to another component (e.g. of the airplane 8) and/or for other purposes than to drive the electric motor 40. Then, one or more additional generators of the airplane 8 may be omitted.

An electrical energy storage 70 is provided to store electrical power and to provide the stored electrical power to the electric motor 40. The electrical energy storage 70 comprises one or more batteries and/or one or more supercapacitors. The electrical energy storage 70 may be electrically coupled to the electric motor 40 directly and/or by means of the frequency converter 60. The electrical power storage 70 may be charged by an electrical grid when available.

The electric motor 40 may receive electrical power from the electrical generator 30 and/or from the electrical power storage 70. Further, one or more thermoelectric generators 72 are provided. For example, the one or more thermoelectric generators 72 may be arranged adjacent to a turbine of the gas turbine engine, such as the low-pressure turbine 19. Since hot combustion gases enter the turbines 17, 19, the turbines 17, 19 and their surroundings are warmer than adjacent areas. Therefore, thermoelectric generators 72 (such as peltier elements) may use a temperature gradient to create electrical power. This power may be used to drive the electric motor 40.

Alternatively or in addition, the gas turbine engine 10 comprises one or more solar panels 71 (see FIG. 2). The one or more solar panels 71 are configured to provide electrical power to the electric motor 40.

FIG. 4 shows an arrangement similar to FIG. 3 for the gas turbine engine 10 according to FIG. 2. According to an embodiment, the gas turbine engine 10 of FIG. 2 comprises the arrangement of FIG. 4. In contrast to FIG. 3, however, the output shaft 41 of the electric motor 40 is fixed to the sun gear 51. The ring gear 54 is fixed to the support structure of the gas turbine engine 10. The planet carrier 53 is fixed to the fan 23.

FIG. 5 shows another arrangement for the gas turbine engine 10 according to FIG. 2. According to an embodiment, the gas turbine engine 10 of FIG. 2 comprises the arrangement of FIG. 5. According to FIG. 5, the epicyclic gearing 50 is arranged between (and adjacent to) the fan 23 and an electric motor 40′. Further, the epicyclic gearing 50 is arranged between the fan 23 and the electrical generator 30.

The electric motor 40′ is arranged between (and adjacent to) the epicyclic gearing 50 and the electrical generator 30. Further, the electric motor 40′ is arranged between the fan 23 and the electrical generator 30.

The electric motor 40′ is arranged coaxially with respect to the principal rotational axis 9 (see FIG. 2). The electric motor 40′ comprises a stator 42 fixed with respect to the support structure of the gas turbine engine 10, and a rotor 43 fixedly connected to the planet carrier 53.

A link 33′ fixedly connects the generator stator 32 with the fan 23. The link 33′ extends through the electric motor 40′. According to FIG. 5, the link 33′ is rotatable with respect to the rotor 43 of the electric motor 40, i.e., the link 33′ runs freely inside the electric motor 40′. The sun gear 51 of the epicyclic gearing 50 is fixed to the link 33′.

FIG. 6 shows a method for controlling the gas turbine engine 10. The method comprises:

Step S1: Magnetically transmitting torque from the low-pressure turbine 19 to the fan 23 by means of the electrical generator 30.

Step S2: Determining a current operating status of the gas turbine engine 10 and/or the aircraft 8 and magnetizing the electrical generator 30 (e.g., the field winding thereof) in dependence of the determined operating status. For example, the current operating status may be one of engine-start, take-off, cruise and landing.

Step S3: Providing electrical power to the electric motor 40; 40′ in dependence on the current operating status of the gas turbine engine 10.

For example, when determining an engine-start, the electrical generator 30 may be magnetized. The generator magnetic field creates torque to the fan 23. The fan 23 then starts to rotate with a lower speed than the shaft 26. At the same time the electrical generator 30 starts to produce electrical power. The produces electrical power is provided to the electric motor 40; 40′ to provide additional torque to the fan 23. Optional excess electrical power may be stored in the electrical energy storage 70.

As another example, when determining a take-off, energy stored in the electrical energy storage 70 is provided to the electric motor 40; 40′, e.g. to produce maximum thrust.

As yet another example, when determining a cruise operation, the electrical energy storage 70 may be charged by the electrical generator 30. When the electrical energy storage 70 is fully charged, all power (mechanical and electrical) transmitted and generated by the electrical generator 30 is used to drive the fan 23. Optionally, additional electrical power from the one or more thermoelectric generators 72 and/or the one or more solar panels 71 may be provided to the electric motor 40; 40′. The flow rate of fuel to the combustion equipment 16 may be correspondingly reduced.

As a further example, then determining a landing, the electrical power stored in the electrical energy storage 70 may be used to boost the fan 23 when necessary.

Thereby, the specific fuel consumption of the gas turbine engine 10 may be reduced.

Thus, by means of the electrical generator 30, power from the shaft 26 is transferred to the fan 23 partly via magnetic coupling and partly electrically by means of the electric motor 40; 40′.

The aircraft 8 may comprise more than one gas turbine engine 10 according to FIG. 2. When a core engine of one of the gas turbine engines 10 fails, electrical power produced by the electrical generator 30 of the other gas turbine engine 10 may be provided to the electric motor 40; 40′ of the gas turbine engine 10 with the failed core so as to rotate the fan 23 thereof and produce thrust.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine. In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

### LIST OF REFERENCE NUMBERS

8 airplane

9 principal rotational axis

10 gas turbine engine

11 engine core

12 air intake

14 low-pressure compressor

15 high-pressure compressor

16 combustion equipment

17 high-pressure turbine

18 bypass exhaust nozzle

19 low-pressure turbine

20 core exhaust nozzle

21 nacelle (support structure)

22 bypass duct

23 propulsive fan (bladed rotor)

24 support structure

26 shaft

27 shaft

29 nose cone

30 electrical generator

31 generator rotor (first generator component)

32 generator stator (second generator component)

33; 33′ link

40; 40′ electric motor

41 output shaft

42 stator

43 rotor

50 epicyclic gearing

51 sun gear

52 planet gear

53 planet carrier

54 ring gear

60 frequency converter

70 electrical energy storage

71 solar panel

72 thermoelectric generator

A core airflow

B bypass airflow

1. A gas turbine engine, in particular for an airplane, comprising:
a bladed rotor,
a shaft driven by a turbine and
an electrical generator including first and second generator components that can be rotated and magnetically coupled to one another, the first one being fixed to the shaft and the second one being mechanically coupled to the bladed rotor so as to drive the bladed rotor.

2. The gas turbine engine according to claim 1, wherein the second generator component is fixed to the bladed rotor.

3. The gas turbine engine according to claim 1, wherein the first generator component is a generator rotor and the second generator component is a generator stator.

4. The gas turbine engine according to claim 1, further comprising an electric motor for driving the bladed rotor.

5. The gas turbine engine according to claim 4, wherein the bladed rotor is arranged between the electrical motor and the electrical generator.

6. The gas turbine engine according to claim 4, wherein the electrical motor is arranged between the bladed rotor and the electrical generator.

7. The gas turbine engine according to claim 4, wherein the electric motor and the bladed rotor are coupled with one another via an epicyclic gearing.

8. The gas turbine engine according to claim 7, wherein the epicyclic gearing is arranged between the bladed rotor and the electrical motor.

9. The gas turbine engine according to claim 4, wherein the electrical generator is configured to provide electrical power to the electric motor.

10. The gas turbine engine according to claim 4, further comprising a frequency converter coupling the electrical generator with the electric motor.

11. The gas turbine engine according to claim 4, further comprising an electrical energy storage to store electrical power and provide electrical power to the electric motor.

12. The gas turbine engine according to claim 11, wherein the energy storage comprises at least one of a battery and a supercapacitor.

13. The gas turbine engine according to claim 11, wherein the energy storage is coupled to at least one of the electrical generator, a solar panel and a thermoelectric generator to receive electrical energy from the at least one of the electrical generator, the solar panel and the thermoelectric generator.

14. The gas turbine engine according to claim 1, wherein the bladed rotor is a fan.

15. An airplane comprising at least one gas turbine engine according to claim 1.

16. A method for operating the gas turbine engine according to claim 1, the method comprising magnetically transmitting torque by means of the electrical generator.

17. The method according claim 16, the method further comprising magnetizing the electrical generator in dependence of a current operating status of the gas turbine engine, wherein the current operating status is one of engine start, take-off, cruise and landing.

18. The method according claim 16, wherein the gas turbine engine further comprises an electric motor for driving the bladed rotor, wherein the method further comprises providing electrical power to the electric motor in dependence on the current operating status of the gas turbine engine.
